(19) United States
(12) Patent Application Publication
(10) Pub. No.: US 2013/0045734 A1
(43) Pub. Date: Feb. 21, 2013

(54) COMMUNICATION SYSTEM AND MOBILE COMMUNICATION TERMINAL

(71) Applicant: Takafumi NAKAMURA, Kawasaki (JP)

(72) Inventor: Takafumi NAKAMURA, Kawasaki (JP)

(73) Assignee: FUJITSU MOBILE COMMUNICATIONS LIMITED, Kawasaki-shi (JP)

(21) Appl. No.: 13/567,417

(22) Filed: Aug. 6, 2012

(30) Foreign Application Priority Data
Aug. 18, 2011 (JP) 2011-179169

(51) Int. Cl. H04W 80/00

(52) U.S. Cl. 455/422.1

(57) ABSTRACT

A communication system includes a first terminal with first and second communication units and an information manager, and a second terminal with third and fourth communication units and an information storage unit. The first communication unit makes a wireless communication with a first base station according to a first protocol using information managed by the information manager. The fourth communication unit makes a wireless communication with the first terminal according to a third protocol and receives information used for a wireless communication with the second base station according to a second protocol.

### CROSS-REFERENCE TO RELATED APPLICATION

This application is based upon and claims the benefit of priority of the prior Japanese Patent Application No. 2011-179169, filed on Aug. 18, 2011, the entire contents of which are incorporated herein by reference.

### FIELD

The embodiments discussed herein are related to a communication system for a mobile communication terminal and a base station, and to the mobile communication terminal.

The mobile communication terminal may also be referred to as a mobile communication terminal equipment or a mobile communication terminal apparatus.

### BACKGROUND

Recent mobile communication terminals include smart phones and feature phones. Because of the relatively large casing and screen and the relatively large number layers in the hierarchical structure of application software, the smart phone may be difficult to manipulate when the smart phone is to be used as a telephone. On the other hand, the feature phone may be easy to manipulate when the feature phone is to be used as a telephone, however, it may be difficult to use a large number of application software in the feature phone as opposed to the smart phone.

When a user wishes to use phones in two environments, namely, the smart phone that has the relatively large screen and variety of application software and the feature phone that is easy to use as a telephone, the user subscribes to a telecommunications carrier or network operator of each of the smart phone and the feature phone. In this case, two UIM (User Identify Module) cards are issued with respect to the smart phone and the feature phone, that is, the two mobile communication terminals. The UIM card is an IC (Integrated Circuit) card that is used in the 3G (3rd Generation mobile telecommunications), and records personal information such as a telephone number and a subscriber ID (Identifier).

On the other hand, a part of the information may be safely duplicated from a SIM (Subscriber Identify Module) card, and a mobile equipment may send a request to the network operator's equipment to clone a subscriber identification information, IMSI (International Mobile Subscriber Identify), stored in the SIM card. The IMSI of the subscriber and an IMEI (International Mobile Equipment Identity) of the mobile equipment are authenticated by the network operator's equipment, in order to generate an IMSI clone. The data stored in the SIM card may be recorded in a storage of the mobile equipment. An example of such a technique is proposed in a Japanese Laid-Open Patent Publication No. 2006-50554.

In addition, a communication terminal may include a storage to store information that forms a basis of a use authorization, and the number of communication terminals sharing the information that forms the basis of the use authorization. The communication terminal may communicate with the other communication terminals sharing the information, judge whether the communication terminal is in a totally shared state in which a communication is possible with all of the other communication terminals sharing the information, and set the communication terminal to a use startable state. When the use of the communication terminal is actually started based on an input made by the user's operation, a use start notification is sent to the other communication terminals sharing the information. The communication terminal that receives the use start notification erases the apparent existence of the information that forms the basis of the use authorization, in order to disable the use of the communication terminal based on the information that forms the basis of the use authorization. An example of such a technique is proposed in a Japanese Laid-Open Patent Publication No. 2007-306169.

Further, a cordless handset of a cordless telephone (or portable telephone) may perform a near field communication using a SIM card substitute with a base station provided with the SIM card, and store SIM information recorded in the SIM card. The cordless handset may communicate with a mobile equipment in order to use the mobile phone service, and output the stored SIM information to the mobile equipment upon request. An example of such a technique is proposed in a Japanese Laid-Open Patent Publication No. 2010-50848.

If the UIM cards are compatible with the smart phone and the feature phone and UIM lock-free, a single UIM card may be used for the smart phone and the feature phone. However, the use of the single UIM card on the smart phone and the feature phone may involve a troublesome operation of extracting the UIM card from one phone and inserting the UIM card into the other phone. This operation may be time consuming, and may be difficult to perform while the user is moving. Furthermore, the simultaneous use of the smart phone and the feature phone to make communications is impossible using the single UIM card.

According to the techniques proposed in the Japanese Laid-Open Patent Publications No. 2006-50554, No. 2007-306169, and No. 2010-50848 described above, it is impossible to set, to a mobile communication terminal not having the UIM card, only one of the plurality of communication protocols usable by the mobile communication terminals having the UIM card. In addition, when the mobile communication terminal having the UIM card uses a first communication protocol and the mobile communication terminal not having the UIM card uses a second communication protocol different from the first communication protocol, these two communication terminals are unable to simultaneously make separate communications.

### SUMMARY

Accordingly, it is an object in one aspect of the embodiment to provide a communication system and a mobile communication terminal that may use the information of one mobile communication terminal and simultaneously enable communications in a plurality of mobile communication terminals using different communication protocols.

According to one aspect of the present invention, a communication system may include a first mobile communication terminal including a first communication unit configured to make a wireless communication with a first base station according to a first protocol and to make a wireless communication with a second base station according to a second protocol, an information manager configured to manage information used for the wireless communication according to one of the first and second protocols, and a second communication unit configured to send information used for a wireless communication with the second base station according to the second protocol to another mobile communication terminal according to a third protocol; and a second mobile communication terminal including a third communication unit, a fourth communication unit configured to make a wireless communication with the first mobile communication terminal according to the third protocol and configured to receive the information used for a wireless communication with the second base station according to the second protocol, and an information storage unit configured to store the information received by the fourth communication unit, wherein the first mobile communication terminal makes the wireless communication with the first base station, according to the first protocol, by the first communication unit using the information managed by the information manager, and wherein the second mobile communication terminal makes a wireless communication with the second base station, according to the second protocol, by the third communication unit using the information stored in the information storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a structure of a main mobile communication terminal in an embodiment;

FIG. 2 is a diagram illustrating a structure of a sub mobile communication terminal in an embodiment;

FIG. 3 is a diagram for explaining a first state;

FIG. 4 is a diagram for explaining a second state;

FIG. 5 is a diagram illustrating a control sequence when starting the mobile communication terminal;

FIG. 6 is a diagram illustrating the control sequence when starting the mobile communication terminal;

FIG. 7 is a diagram illustrating the control sequence when starting the mobile communication terminal;

FIG. 8 is a diagram for explaining a control sequence when requesting delivery of UIM information; and

FIG. 9 is a diagram for explaining a control sequence when using a UIM card from the sub mobile communication terminal.

### DESCRIPTION OF EMBODIMENTS

Preferred embodiments of the present invention will be described with reference to the accompanying drawings.

According to one aspect of the embodiment, two mobile communication terminals, namely, a main mobile communication terminal and a sub mobile communication terminal, may be used. For example, the main mobile communication terminal may be formed by a feature phone, and the sub mobile communication terminal may be formed by a smart phone. Of course, by taking into consideration how frequent each phone may be used and the like, the main mobile communication terminal may be formed by the smart phone, and the sub mobile communication terminal may be formed by the feature phone.

A description will now be given of the communication system and the mobile communication terminal in each embodiment according to the present invention.

<Structure of Main Mobile Communication Terminal>

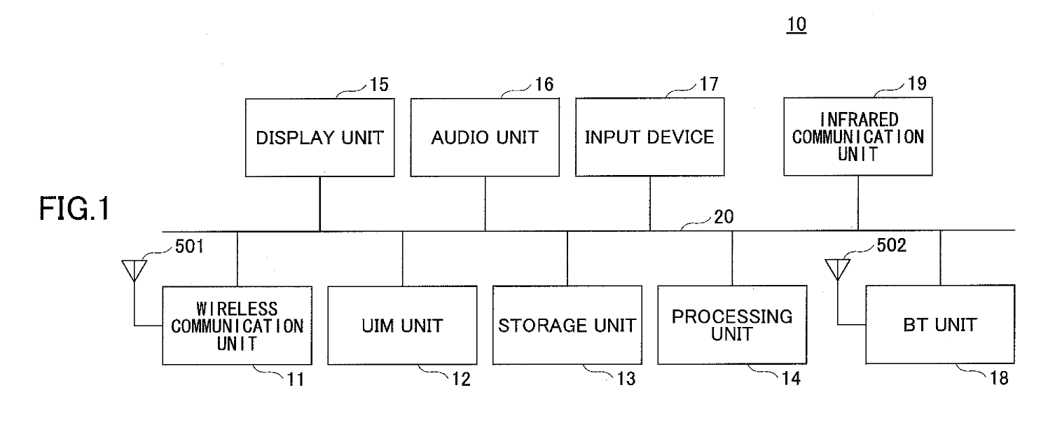

FIG. 1 is a diagram illustrating a structure of the main mobile communication terminal in an embodiment. A main mobile communication terminal 10 illustrated in FIG. 1 includes a wireless communication unit 11, a UIM unit 12, a storage unit 13, a processing unit (or computing unit) 14, a display unit 15, an audio unit 16, an input device 17, a BT (Bluetooth, registered trademark) unit 18, and an infrared communication unit 19 that are connected via a bus 20.

The wireless communication unit 11 may make a wireless communication with a base station (not illustrated) using two wireless protocols. For example, the two wireless protocols may be CDMA1× (Code Division Multiple Access 1×) for audio communication, and EV-DO (Evolution Data Only (Optimized)) for data communication. The wireless communication unit 11 may modulate a transmitting signal supplied from the processing unit 14 or the audio unit 16, and send the modulated signal to the base station via an antenna 501. In addition, the wireless communication unit 11 may demodulate a reception signal received via the antenna 501, and supply the demodulated signal to the processing unit 14 or the audio unit 16.

A UIM card may be loaded into the UIM unit 12. The UIM card may be formed by an IC card, and manage UIM information for use in a wireless communication between the main mobile communication terminal 10 and a base station (not illustrated). For example, the UIM information includes information used by the CDMA1× protocol and the EV-DO protocol. In other words, the UIM card may store, with respect to each of the CDMA1× protocol and the EV-DO protocol, first UIM information that may be physically copied and used, such as subscriber information, a telephone number of the main mobile communication terminal 10, a SMS (Short Message Service), accumulated charge of calls, and the like. In addition, second UIM information, used by the CDMA1× protocol and the EV-DO protocol, may be generated when an operation is performed using an authenticating function (application software) within the UIM card, the UIM card itself is accessed, and the like. In the following description, the first UIM information and the second UIM information may be generally referred to as UIM information.

The processing unit 14 may execute various processing programs stored in the storage unit 13. The various processing programs, when executed by the processing unit 14, may perform a control process with respect to parts within the main mobile communication terminal 10, a coding process on a transmitting signal, a decoding process on the reception signal, and the like. In addition, the storage unit 13 may store UIM delivery information to be described later, indicating main mobile communication terminal 10 or a sub mobile communication terminal 30 that uses the CDMA1× protocol and the EV-DO protocol.

The display unit 15 may display various character information and image information such as a screen, under the control of the processing unit 14. The audio unit 16 may digitize an analog audio signal output from a microphone (not illustrated) that picks up sound, and supply the digital audio signal to the wireless communication unit 11 or the processing unit 14. In addition, the audio unit 16 may convert a digital audio signal supplied from the wireless communication unit 11 or the processing unit 14 into an analog signal, and supply the analog audio signal to a speaker (not illustrated) that produces sound. It is assumed for the sake of convenience in FIG. 1 that the microphone and the speaker are included in the audio unit 16.

The input device 17 may include various keys that are manipulated by the user when inputting a telephone number, a character, and the like. The various keys may include a ten-key, a call key, a select key, a submit key, a clear key, and the like. The input made from the input device 17 is supplied to the processing unit 14.

The BT unit 18 may exchange data with a BT unit of the sub mobile communication terminal 30 or other mobile communication terminals, by a near field communication such as the Bluetooth (registered trademark). The infrared communication unit 19 may exchange data with an infrared communication unit of the sub mobile communication terminal 30 or other mobile communication terminals, by an infrared communication.

<Structure of Sub Mobile Communication Terminal>

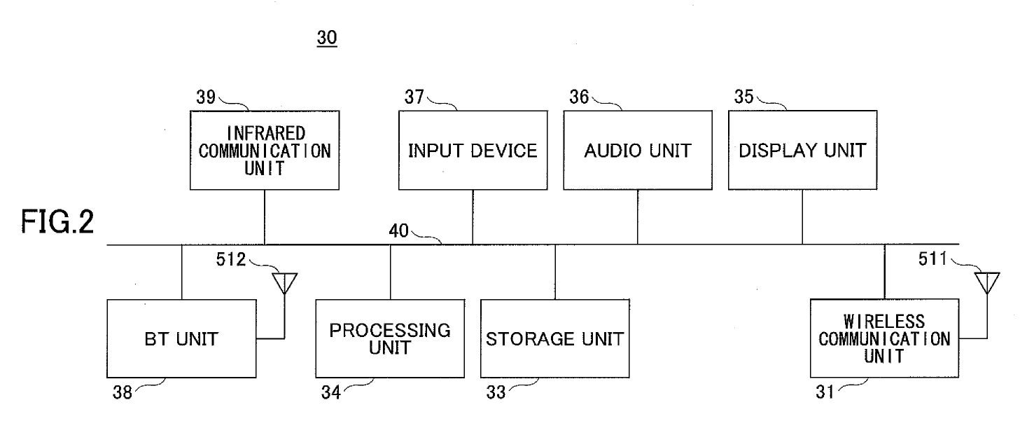

FIG. 2 is a diagram illustrating a structure of the sub mobile communication terminal in an embodiment. The sub mobile communication unit 30 illustrated in FIG. 2 includes a wireless communication unit 31, a storage unit 33, a processing unit (or computing unit) 34, a display unit 35, an audio unit 36, an input device 37, a BT unit 38, and an infrared communication unit 39 that are connected via a bus 40. The sub mobile communication terminal 30 includes no UIM unit.

The wireless communication unit 31 may make a wireless communication with the base station using two wireless protocols. For example, the two wireless protocols may be CDMA1× for audio communication, and EV-DO for data communication. The wireless communication unit 31 may modulate a transmitting signal supplied from the processing unit 34 or the audio unit 36, and send the modulated signal to the base station via an antenna 511. In addition, the wireless communication unit 31 may demodulate a reception signal received via the antenna 511, and supply the demodulated signal to the processing unit 34 or the audio unit 36.

The processing unit 34 may execute various processing programs stored in the storage unit 33. The various processing programs, when executed by the processing unit 34, may perform a control process with respect to parts within the sub mobile communication terminal 30, a coding process on a transmitting signal, a decoding process on the reception signal, and the like. In addition, the storage unit 33 may store the first UIM information and the UIM delivery information supplied from the main mobile communication terminal 10.

The display unit 35 may display various character information and image information such as a screen, under the control of the processing unit 34. The audio unit 36 may digitize an analog audio signal output from a microphone (not illustrated) that picks up sound, and supply the digital audio signal to the wireless communication unit 31 or the processing unit 34. In addition, the audio unit 36 may convert a digital audio signal supplied from the wireless communication unit 31 or the processing unit 34 into an analog signal, and supply the analog audio signal to a speaker (not illustrated) that produces sound. It is assumed for the sake of convenience in FIG. 1 that the microphone and the speaker are included in the audio unit 36.

The input device 37 may include various keys that are manipulated by the user when inputting a telephone number, a character, and the like. The various keys may include a ten-key, a call key, a select key, a submit key, a clear key, and the like. The input made from the input device 37 is supplied to the processing unit 34.

The BT unit 38 may exchange data with a BT unit of the main mobile communication terminal 10 or other mobile communication terminals, by a near field communication such as the Bluetooth. The infrared communication unit 39 may exchange data with an infrared communication unit of the main mobile communication terminal 10 or other mobile communication terminals, by an infrared communication.

In this embodiment, the main mobile communication terminal 10 is physically loaded with the UIM card into the UIM unit 12, and the sub mobile communication terminal 30 is not physically loaded with the UIM card. The sub mobile communication terminal 30 may temporarily use the UIM information in the UIM card of the main mobile communication terminal 10, in order that the single UIM card may be used by the two mobile communication terminals 10 and 30.

The UIM information may be transmitted between the main and sub mobile communication terminals 10 and 30, using the BT units 18 and 38. Hence, the troublesome operation of loading and unloading the UIM card between the main and sub mobile communication terminals 10 and 30 may be avoided. Furthermore, the UIM information may be transmitted between the main and sub mobile communication terminals 10 and 30, using the infrared communication units 19 and 39, for example, instead of using the BT units 18 and 38.

The UIM information in the UIM card may be partially allocated to the main and sub mobile communication terminals 10 and 30. Hence, the single UIM card may be used simultaneously by the main and sub mobile communication terminals 10 and 30. In the case in which the UIM information of the CDMA1× protocol and the UIM information of the EV-DO protocol are stored in the UIM card, the UIM information of the CDMA1× protocol may be copied from the UIM card loaded into the UIM unit 12 of the main mobile communication terminal 10 to the storage unit 33 of the sub mobile communication terminal 30 using the BT units 18 and 38. In this case, the main mobile communication terminal 10 may perform the wireless communication by the wireless communication unit 11 using the UIM information of the CDMA1× protocol, and the sub mobile communication terminal 30 may perform the wireless communication by the wireless communication unit 31 using UIM information of the EV-DO protocol.

In addition, the UIM delivery information indicating the allocation state of the UIM information may be stored in the main and sub mobile communication terminals 10 and 30. Each of the main and sub mobile communication terminals 10 and 30 may be provided with a function to turn the corresponding one of the wireless communication units 11 and 31 ON or OFF, according to the UIM delivery information.

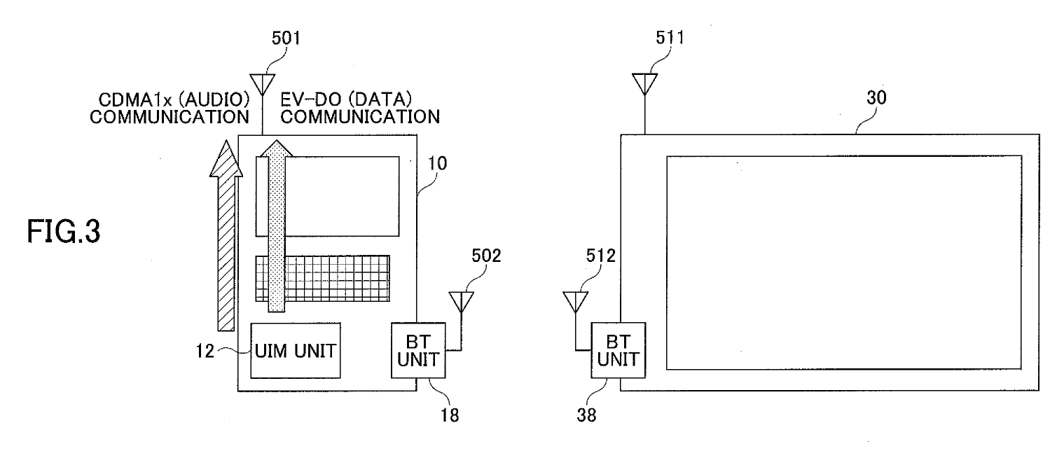

FIG. 3 is a diagram for explaining a first state. In the first state, the main mobile communication terminal 10 may perform the communication (audio) using the CDMA1× protocol and the communication (data) using the EV-DO protocol, and no wireless function may be provided the sub mobile communication terminal 30. Normally, the wireless communication unit 11 of the main mobile communication terminal 10 uses the UIM information of the CDMA1× protocol and the UIM information of the EV-DO protocol in the UIM card that is loaded into the UIM unit 12. Hence, the wireless communication unit 11 may perform the communication (audio) using the CDMA1× protocol as indicated by an arrow with a hatching, and the communication (data) using the EV-DO protocol as indicated by an arrow with a halftone dot meshing. The wireless communication unit 30 of the sub mobile communication terminal 30 has no UIM information of the CDMA1× protocol and no UIM information of the EV-DO protocol, and no wireless communication may be made by the wireless communication unit 31.

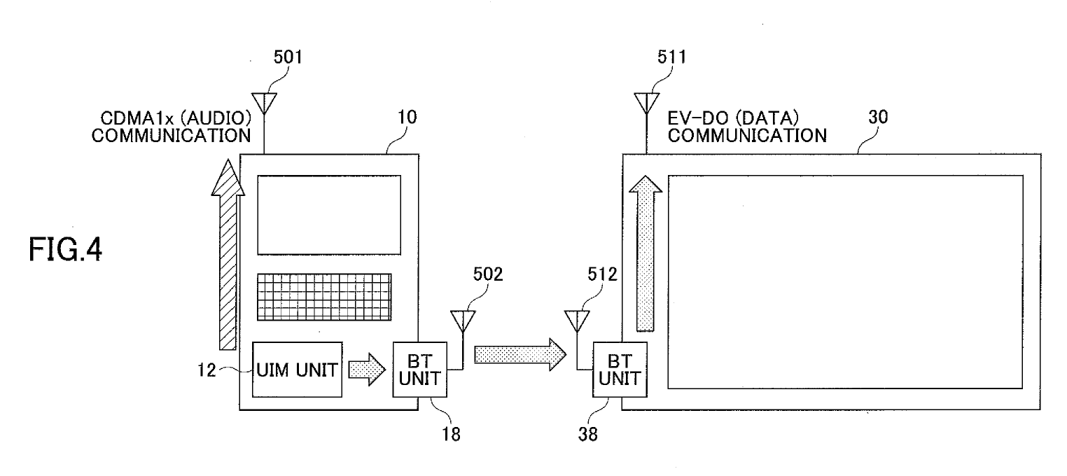

FIG. 4 is a diagram for explaining a second state. In the second state, the main mobile communication terminal 10 may perform the communication (audio) using the CDMA1× protocol, and the sub mobile communication terminal 30 may perform the communication (data) using the EV-DO protocol. As illustrated in FIG. 4, the UIM information of the EV-DO protocol in the UIM card that is loaded into the UIM unit 12 of the main mobile communication terminal 10 may be sent to the sub mobile communication terminal 30 by the BT units 18 and 38, and stored in the storage unit 33.

The wireless communication unit 11 of the main mobile communication terminal 10 may use the UIM information of the CDMA1x protocol in the UIM card, and perform the communication using the CDMA1× protocol as indicated by an arrow with a hatching. In addition, the wireless communication unit 31 of the sub mobile communication terminal 30 may use the UIM information of the EV-DO protocol in the storage unit 33, and perform the communication using the EV-DO protocol as indicated by an arrow with a halftone dot meshing.

In this state, the wireless functions of the wireless communication units 11 and 31 may be controlled based on the UIM delivery information stored in the storage units 13 and 33, respectively, in order to disable the communication function of the wireless communication unit 11 using the EV-DO protocol in the main mobile communication terminal 10, and disable the communication function of the wireless communication unit 31 using the CDMA1× protocol in the sub mobile communication terminal 30.

On the other hand, a server (not illustrated) that is connected to the base station may perform a management to permit (or tolerate) access from two different systems, namely, the CDMA1× protocol system and the EV-DO protocol system, by the two mobile communication terminals 10 and 30 having identical UIM information. When these two conditions are satisfied, the two mobile communication terminals 10 and 30 may use the identical UIM information and simultaneously make access to the two systems, namely, the CDMA1× protocol system and the EV-DO protocol system. In addition, simultaneous access from the two mobile communication terminals 10 and 30 to one of the two systems, that is, the CDMA1× protocol system or the EV-DO protocol system, may be prevented.

In this embodiment, the two systems are the CDMA1× protocol system and the EV-DO protocol system, however, an arbitrary combination of systems may be used and an arbitrary managing method may be employed, as long as the managing method employed by the server permits access from two systems by the two mobile communication terminals 10 and 30 having the identical UIM information.

<Start Sequence>

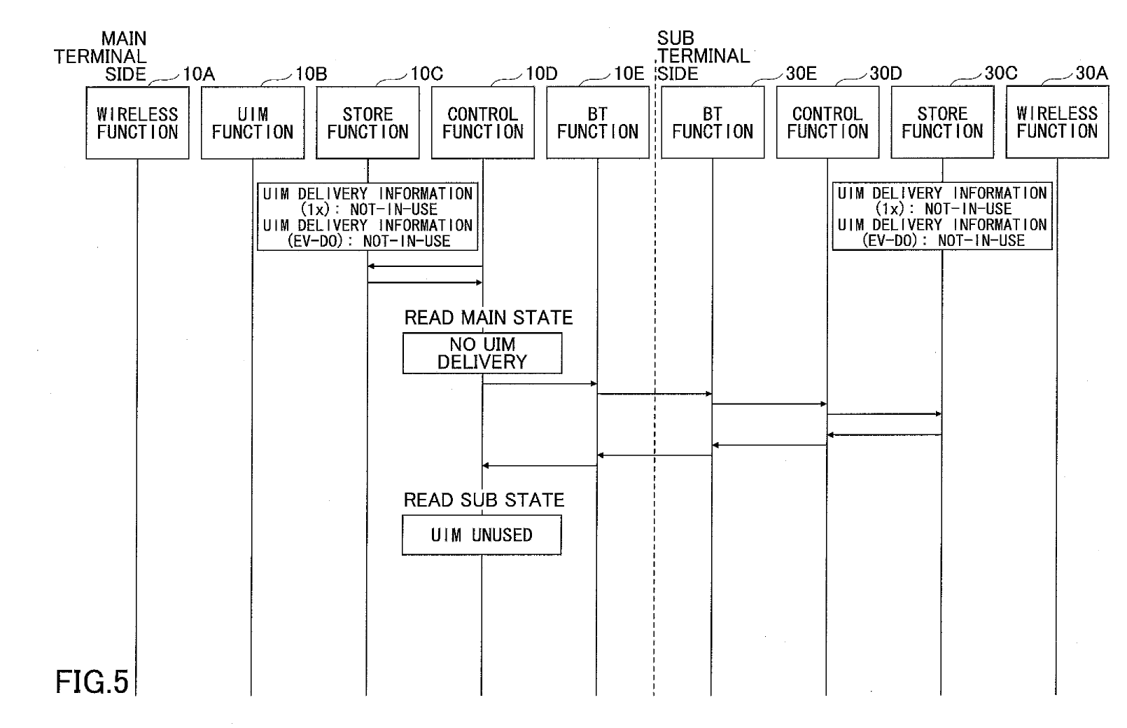

FIGS. 5, 6, and 7 are diagrams illustrating a control sequence when starting the main mobile communication terminal 10. In FIGS. 5 through 7, a wireless function 10A denotes a function to control the wireless communication unit 11 by a task of the program running on the processing unit 14, and a UIM function 10B denotes a function to control the UIM unit 12 by a task of the program running on the processing unit 14. A store function 10C denotes a function to control the storage unit 13 by a task of the program running on the processing unit 14, and a control function 10D denotes a function to control delivery and the like of the UIM information by a task of the program running on the processing unit 14. A BT function 10E denotes a function to control the BT unit 18 by a task of the program running on the processing unit 14.

In addition, a wireless function 30A denotes a function to control the wireless communication unit 31 by a task of the program running on the processing unit 34, and a store function 30C denotes a function to control the storage unit 33 by a task of the program running on the processing unit 34. A control function 30D denotes a function to control delivery and the like of the UIM information by a task of the program running on the processing unit 34, and a BT function 30E denotes a function to control the BT unit 38 by a task of the program running on the processing unit 34.

In FIG. 5, the control function 10D may read the UIM delivery information of the main mobile communication terminal 10 from the storage function 10C. In this example, the UIM delivery information (1×) of the CDMA1× protocol system is “no delivery (not-in-use)”, and the UIM delivery information (EV-DO) of the EV-DO protocol system is “no delivery (not-in-use)”, in the main mobile communication terminal 10.

Next, the control function 10D may read the UIM delivery information from the store function 30C of the sub mobile communication terminal 30, via the BT functions 10E and 30E and the control function 30D. The UIM delivery information (1×) of the CDMA1× protocol system is “no delivery (not-in-use)”, and the UIM delivery information (EV-DO) of the EV-DO protocol system is “no delivery (not-in-use)”, in the sub mobile communication terminal 30.

In other words, the UIM delivery information of the CDMA1x protocol system and the UIM delivery information of the EV-DO protocol system match in the main and sub mobile communication terminals 10 and 30, and the control function 10D may recognize that the UIM information is unused in the sub mobile communication terminal 30.

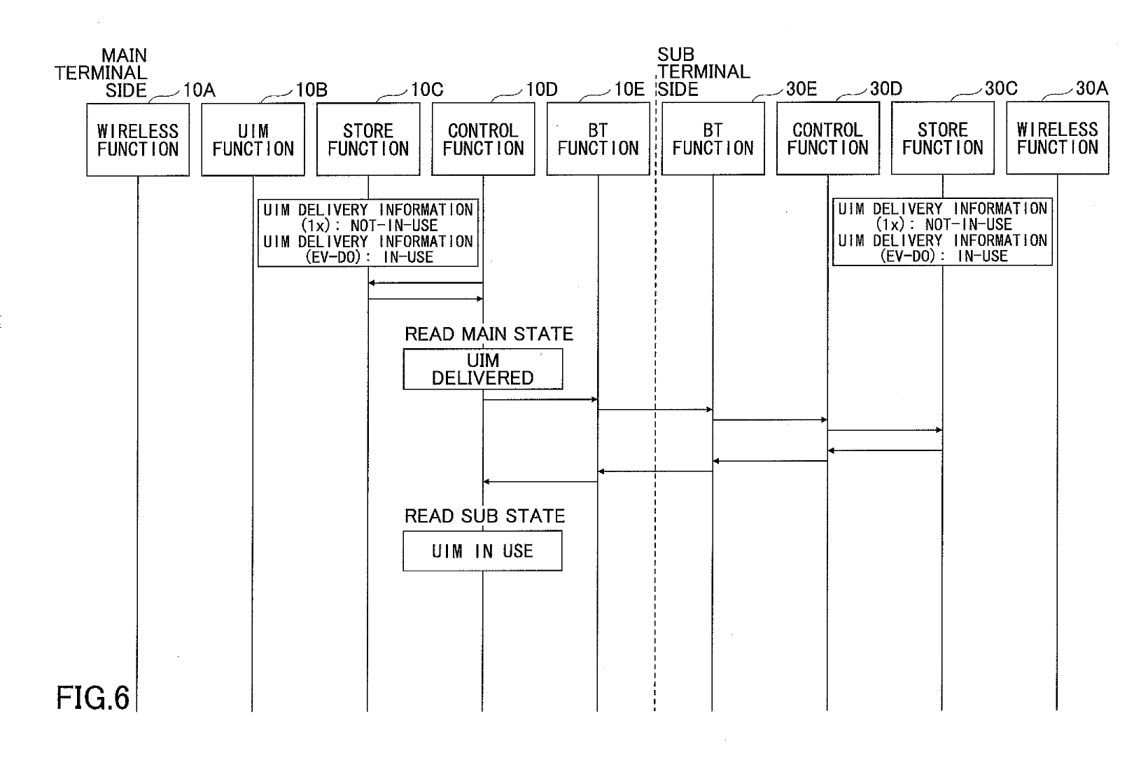

In FIG. 6, the control function 10D may read the UIM delivery information of the main mobile communication terminal 10 from the store function 10C. In this example, the UIM delivery information (1×) of the CDMA1× protocol system is “no delivery (not-in-use)”, and the UIM delivery information (EV-DO) of the EV-DO protocol system is “delivered (in-use)”, in the main mobile communication terminal 10.

Next, the control function 10D may read the UIM delivery information from the store function 30C of the sub mobile communication terminal 30, via the BT functions 10E and 30E and the control function 30D. The UIM delivery information (1×) of the CDMA1× protocol system is “no delivery (not-in-use)”, and the UIM delivery information (EV-DO) of the EV-DO protocol system is “delivered (in-use)”, in the sub mobile communication terminal 30.

In other words, the UIM delivery information of the CDMA1x protocol system and the UIM delivery information of the EV-DO protocol system match in the main and sub mobile communication terminals 10 and 30, and the control function 10D may recognize that the UIM information of the EV-DO protocol is in-use in the sub mobile communication terminal 30.

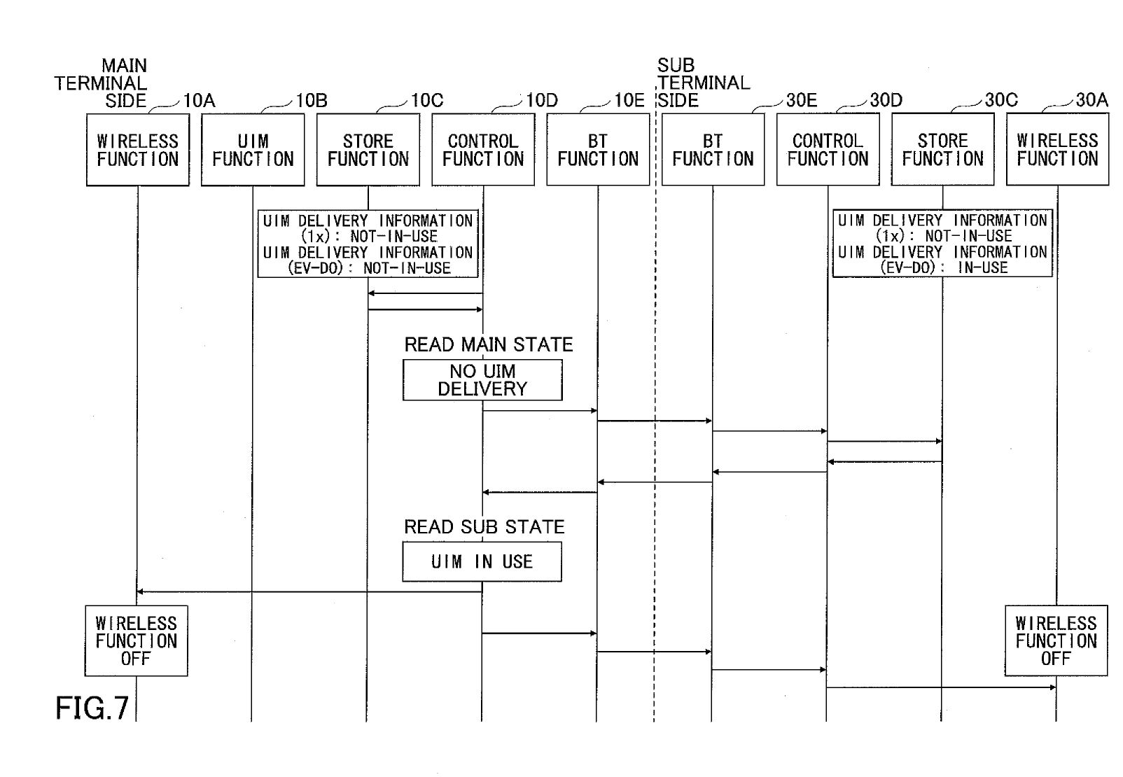

In FIG. 7, the control function 10D may read the UIM delivery information of the main mobile communication terminal 10 from the store function 10C. In this example, the UIM delivery information (1×) of the CDMA1× protocol system is “no delivery (not-in-use)”, and the UIM delivery information (EV-DO) of the EV-DO protocol system is “no delivery (not-in-use)”, in the main mobile communication terminal 10.

Next, the control function 10D may read the UIM delivery information from the store function 30C of the sub mobile communication terminal 30, via the BT functions 10E and 30E and the control function 30D. The UIM delivery information (1×) of the CDMA1× protocol system is “no delivery (not-in-use)”, and the UIM delivery information (EV-DO) of the EV-DO protocol system is “delivered (in-use)”, in the sub mobile communication terminal 30.

In other words, the UIM delivery information of the CDMA1x protocol system and the UIM delivery information of the EV-DO protocol system do not match in the main and sub mobile communication terminals 10 and 30, and the control function 10D may recognize that the UIM information of the EV-DO protocol is in-use in the sub mobile communication terminal 30. For this reason, the control function 10D may stop (or disable or turn OFF) the wireless function 10A, and the control function 10D may stop (or disable or turn OFF) the wireless function 30A, via the BT functions 10E and 30E and the control function 30D.

FIGS. 5 through 7 illustrate the control sequence when starting the main mobile communication terminal 10, however, a similar control sequence may be executed in the sub mobile communication terminal 30 when starting the sub mobile communication terminal 30.

<UIM Information Delivery Request>

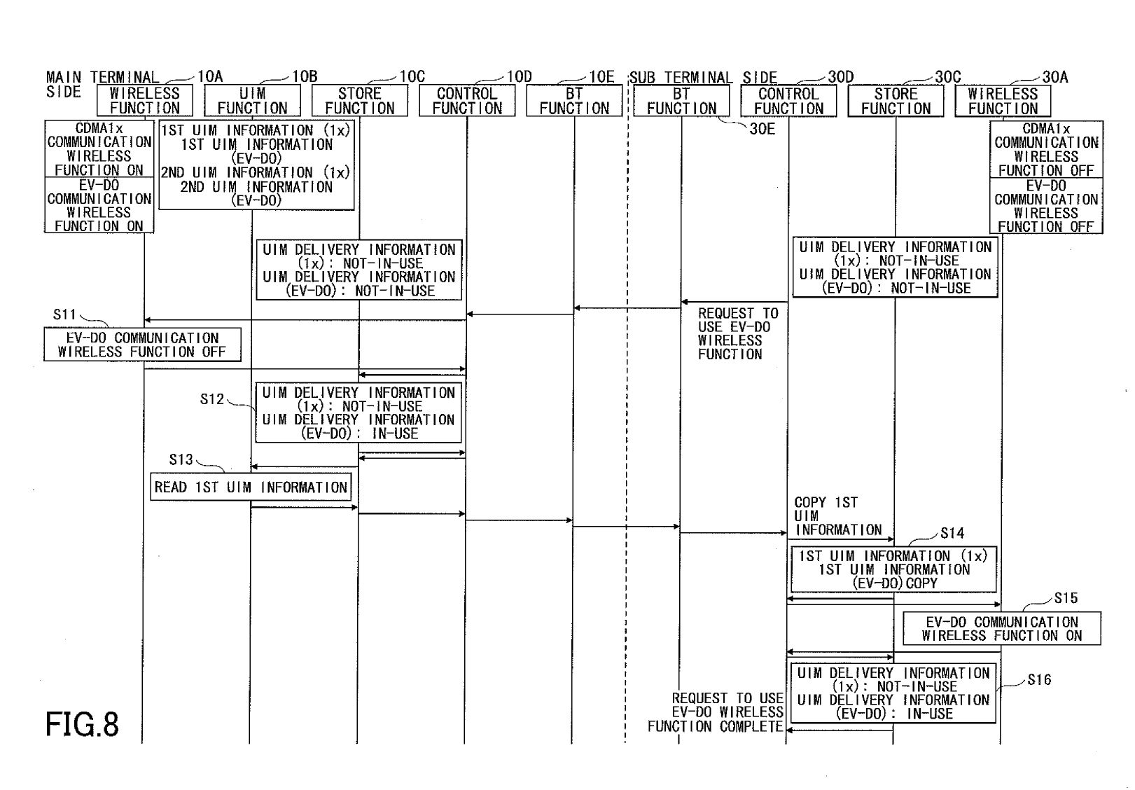

FIG. 8 is a diagram for explaining a control sequence when requesting delivery of the UIM information from the sub mobile communication terminal 30. In FIG. 8, it is assumed that initially, the UIM delivery information (1×) of the CDMA1× protocol system is “no delivery (not-in-use)”, and the UIM delivery information (EV-DO) of the EV-DO protocol system is “no delivery (not-in-use)” in the store function 30C of the sub mobile communication terminal 30.

The control function 30D may send a request to use the wireless function of the EV-DO protocol with respect to the main mobile communication terminal 10, in response to an input from the input device 37 or the like. This request to use the wireless function of the EV-DO reaches the control function 10D, via the BT functions 30E and 10E. Hence, the control function 10D may stop the wireless function of the EV-DO communication of wireless function 10A (step S11). In response to a wireless function stop notification, the control function 10D may rewrite the UIM delivery information (1×) of the CDMA1× protocol system to “no delivery (not-in-use)”, and the UIM delivery information (EV-DO) of the EV-DO protocol system to “delivered (in-use)”, in the store function 10C of the main mobile communication terminal 10 (step S12).

The control function 10D may read the first UIM information of the CDMA1× protocol and the EV-DO protocol from the UIM function 10B (step S13). The first UIM information of the CDMA1× protocol and the EV-DO protocol may be supplied to the control function 30D, via the BT functions 10E and 30E, and the control function 30D may store the first UIM information of the CDMA1× protocol and the EV-DO protocol in the store function 30C (step S14).

The control function 30D may start the wireless function of the EV-DO communication of the wireless function 30A (step S15). In addition, the control function 30D may rewrite the UIM delivery information (1×) of the CDMA1× protocol system to “no delivery (not-in-use)”, and the UIM delivery information (EV-DO) of the EV-DO protocol system to “delivered (in-use)”, in the store function 30C of the sub mobile communication terminal 30 (step S16).

FIG. 8 illustrates the UIM delivery from the sub mobile communication terminal 30, however, the UIM delivery from the main mobile communication terminal 10 may be performed by a control sequence similar to that illustrated in FIG. 8. Further, when sending a delivery cancel request for the UIM information from the sub mobile communication terminal 30, the delivery of the UIM information may be cancelled in a manner similar to when the delivery of the UIM information is requested in FIG. 8.

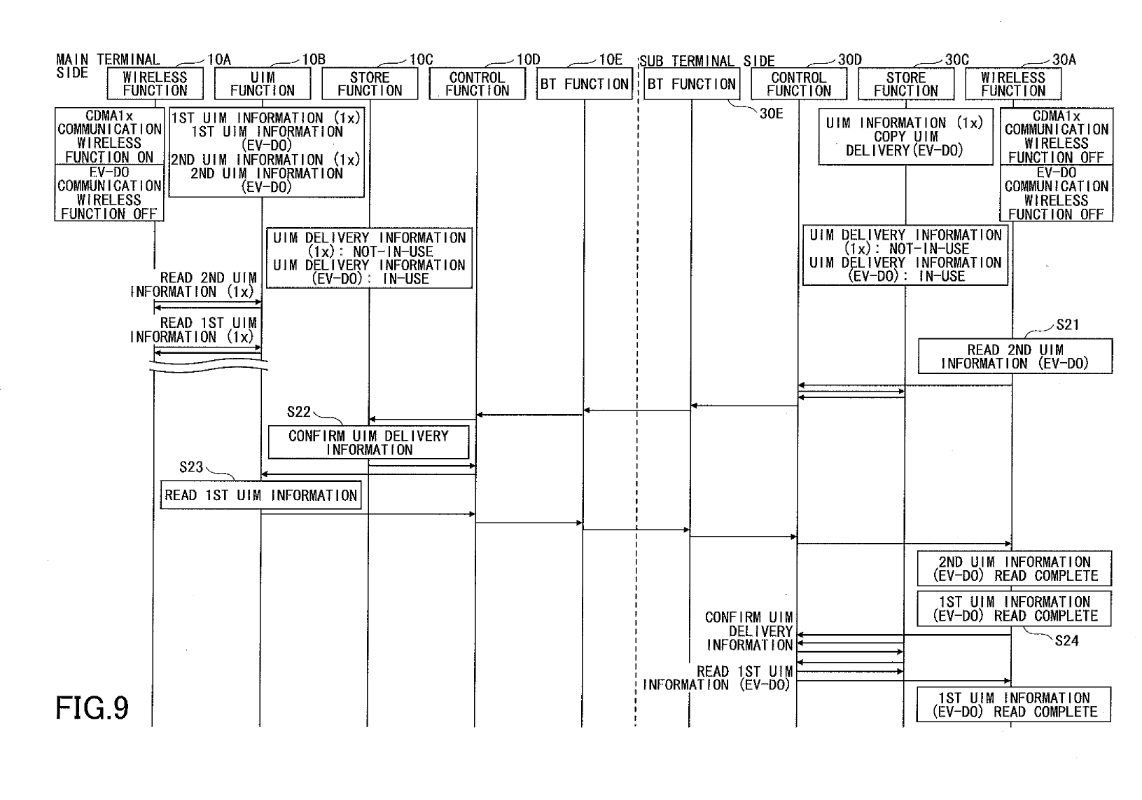

FIG. 9 is a diagram for explaining a control sequence when using the UIM card from the sub mobile communication terminal 30. In FIG. 9, it is assumed that initially, the UIM delivery information (1×) of the CDMA1× protocol system is “no delivery (not-in-use)”, and the UIM delivery information (EV-DO) of the EV-DO protocol system is “delivered (in-use)” in the store function 30C of the sub mobile communication terminal 30.

When the wireless function 30A of the sub mobile communication terminal 30 is to use the UIM information of the EV-DO protocol, the wireless function 30A may request generation of the second UIM information of the EV-DO protocol with respect to the control function 30D (step S21). The control function 30D may confirm the UIM delivery information in the store function 30C of the sub mobile communication terminal 30. In this example, the UIM delivery information (EV-DO) of the EV-DO protocol is “delivered (in-use)”, and thus, the control function 30D may request confirmation of the UIM delivery information to the control function 10D of the main mobile communication terminal 10, via the BT functions 30E and 10E.

Accordingly, the control function 10D may confirm the UIM delivery information of the main mobile communication terminal 10 to the store function 10C (step S22), and confirm that the UIM delivery information (EV-DO) of the EV-DO protocol is “delivered (in-use)”. Thereafter, the control function 10D may request generation of the second UIM information of the EV-DO protocol with respect to the UIM function 10B (step S23). Hence, the control function 10D may supply the second UIM information of the EV-DO protocol generated by the UIM function 10B to the wireless function 30A, via the BT functions 10E and 30E and the control function 30D.

On the other hand, the first UIM information of the EV-DO protocol, not requiring access to the UIM card itself, is already stored in the store function 30C of the sub mobile communication terminal 30. For this reason, when the wireless function 30A requests reading of the first UIM information of the EV-DO protocol to the control function 30D (step S24), the control function 30D may confirm the UIM delivery information in the store function 30C. Because the UIM delivery information (EV-DO) in the store function 30C is “delivered (in-use)”, the control function 30D may read the first UIM information of the EV-DO protocol from the store function 30C and supply this first UIM information to the wireless function 30A.

Accordingly, the wireless function 30 may use the first UIM information of the EV-DO protocol. By storing a part of the UIM card function (or first UIM information) in the sub mobile communication terminal 30, the number of accesses made via the BT function 10E of the main mobile communication terminal 10 and the BT function 30E of the sub mobile communication terminal 30 may be reduced, and the current consumption may be reduced.

In this state, in the main mobile communication terminal 10, the wireless function 10A of the CDMA1× protocol may also use the UIM function 10B. Hence, the wireless function of the CDMA1× protocol may be used in the main mobile communication terminal 10 and the wireless function of the EV-DO protocol may be used in the sub mobile communication terminal 30, using the single UIM card.

In FIG. 9, the first UIM information and the second UIM information are illustrated separately depending on whether the calculation is performed by the application software of the UIM card. However, the first UIM information may include specific information to be updated in real-time by the application software running in the main and sub mobile communication terminals 10 and 30. In this case, the specific information may be stored in the store function 30C of the sub mobile communication terminal 30, and at the same time, the specific information in the UIM function 10B of the main mobile communication terminal 10 may be updated by a procedure similar to that for the second UIM information. The physical reading method of the UIM information may be set depending on the purpose of using the UIM information.

The management using the UIM delivery information may be preferred in order to perform an exclusive operation that does not generate a mismatch of UIM information, such as the two mobile communication terminals 10 and 30 using the UIM information (for example, the UIM information of the EV-DO protocol) of the single UIM card. To prepare for a case in which the UIM delivery information is destroyed, the control function 10D of the main mobile communication terminal 10 may periodically monitor the UIM delivery information of the sub mobile communication terminal 30 in order to reduce the risk of the exclusive operation. In this case, when an abnormal state is detected in which the mismatch occurs between the UIM delivery information of the sub mobile communication terminal 30 and the UIM delivery information of the main mobile communication terminal 10, the control function 10D may carry out a control to stop the use of the UIM information from the sub mobile communication terminal 30 and to the use the UIM information from the main mobile communication terminal 10.

In addition, in order to reduce the risk of the exclusive operation, the control function 10D may manage the UIM delivery information by adding an expiry date (or expiry time) to the UIM delivery information, and notify the expiry date to the sub mobile communication terminal 30. The expiry date indicates the time when the usable state (or usability) of the UIM information in the sub mobile communication terminal 30 expires. When the expiry date arrives (or is reached) in the sub mobile communication terminal 30, the control function 30D may automatically change the UIM delivery information from “delivered (in-use)” to “no delivery (not-in-use)”. At the same time, when the expiry date arrives in the main mobile communication terminal 10, the control function 10D may automatically change the UIM delivery information from “delivered (in-use)” to “no delivery (not-in-use)”. In this case, the state indicated by the UIM delivery information may be returned to the original state without making a communication between the main and sub mobile communication terminals 10 and 30. The expiry date may be designated to 2 hours, 1 day, and the like, from a user interface such as the input device 17.

In this embodiment, the communication between the main and sub mobile communication terminals 10 and 30 is performed via the BT functions 10E and 30E. However, the communication between the main and sub mobile communication terminals 10 and 30 may be performed via a cable using connectors and the like, or by a wireless communication via a wireless LAN (Local Area Network) and the like. In addition, signals used to send the UIM information may be subjected to an enciphering process.

According to this embodiment, two mobile communication terminals, namely, a smart phone that has the relatively large screen and variety of application software and a feature phone that is easy to use as a telephone, for example, may use a single UIM card when preferred. In addition, one of the two mobile communication terminals may perform an audio communication and the other of the two mobile communication terminals may perform a data communication, simultaneously, to improve the convenience to the user.

In this embodiment, the manufacturer's serial number that is unique to the mobile communication terminal may be identical for the main mobile communication terminal 10 and the sub mobile communication terminal 30, by regarding a combination of the main and sub mobile communication terminals 10 and 30 as a single terminal. When different serial numbers are assigned to the main and sub mobile communication terminals 10 and 30, the two mobile communication terminals 10 and 30 having different serial numbers will make access using the same telephone number, and thus, the network operator may make modification to permit such an access.

For example, the main mobile communication terminal 10 may be created according to specifications targeting mainly international standards, and the sub mobile communication terminal 30 may be created to utilize specialized or characteristic functions of a particular network operator. In this case, the main mobile communication terminals 10 may be created according to essentially the same specifications, and the development cost may be reduced. In addition, a user who owns different models of feature phones may simultaneously use a smart phone in addition to the feature phone.

The allocation of the UIM information to the mobile communication terminals 10 and 30 is not limited to the wireless function, and may be applied to other functions such as a digital television (1 SEG (Japanese terrestrial digital broadcasting service for mobile devices)) and the like using the UIM information.

Information limited to within the mobile communication terminal may be moved between the main and sub mobile communication terminals 10 and 30. When the serial numbers of the main and sub mobile communication terminals 10 and 30 are different, another UIM card may be loaded to the sub mobile communication terminal 30 when the simultaneous full use of the functions of the main and sub mobile communication terminals 10 and 30 is preferred. In this case, the main and sub mobile communication terminals 10 and 30 may be used independently as independent mobile communication terminals. Moreover, the main and sub mobile communication terminals 10 and 30 may be physically fixed and connected by a cable, in order to automatically end the UIM function of the sub mobile communication terminal 30 when the cable connection is made.

Therefore, according to the communication system and the mobile communication terminal disclosed above, the information of one mobile communication terminal may be used to simultaneously enable communications in a plurality of mobile communication terminals using different communication protocols, as described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a first mobile communication terminal including:
a first communication unit configured to make a wireless communication with a first base station according to a first protocol and to make a wireless communication with a second base station according to a second protocol;
an information manager configured to manage information used for the wireless communication according to one of the first and second protocols; and
a second communication unit configured to send information used for a wireless communication with the second base station according to the second protocol to another mobile communication terminal according to a third protocol; and
a second mobile communication terminal including:
a third communication unit;
a fourth communication unit configured to make a wireless communication with the first mobile communication terminal according to the third protocol and configured to receive the information used for a wireless communication with the second base station according to the second protocol; and
an information storage unit configured to store the information received by the fourth communication unit,
wherein the first mobile communication terminal makes the wireless communication with the first base station, according to the first protocol, by the first communication unit using the information managed by the information manager, and
wherein the second mobile communication terminal makes a wireless communication with the second base station, according to the second protocol, by the third communication unit using the information stored in the information storage unit.

2. The communication system as claimed in claim 1, wherein
the first mobile communication terminal further includes a first state storage unit configured to store a state of use of the protocol used by each of the first and third communication units,
a second mobile communication unit further includes a second state storage unit configured to store a state of use of the protocol used by each of the first and third communication units, and
one of the first and second mobile communication units further includes a controller configured to stop the first and third communication units when the state of use stored in the first state storage unit and the state of use stored in the second state storage unit differ.

3. The communication system as claimed in claim 2, wherein the information used for the wireless communication according to one of the first and second protocols includes first information stored in the information manager and second information generated by the information manager, and the information stored in the information storage unit is the first information.

4. The communication system as claimed in claim 3, wherein
the second communication unit receives a request for the second information sent from the fourth communication unit of the second mobile communication terminal and supplies the received request to the information manager, and
the information manager generates the second information in response to the request for the second information and sends the generated second information from the second communication unit to the fourth communication unit.

5. The communication system as claimed in claim 2, wherein
an expiry date is provided with respect to the state of use of the protocol used by the third communication unit and stored in the first and second state storage units, and
the controller changes the state of use of the protocol used by the third communication unit and stored in the first and second state storage units to not-in-use, when the expiry date is reached.

6. A first mobile communication terminal comprising:
a first communication unit configured to make a wireless communication with a first base station according to a first protocol and to make a wireless communication with a second base station according to a second protocol;
an information manager configured to manage information used for the wireless communication according to one of the first and second protocols; and
a second communication unit configured to send information used for a wireless communication with the second base station according to the second protocol to another mobile communication terminal according to a third protocol,
wherein the first mobile communication terminal is communicatable in a communication system that includes a second mobile communication terminal including a third communication unit, a fourth communication unit configured to receive information used for a wireless communication with the first mobile communication terminal according to the second protocol, and an information storage unit configured to store the information received by the fourth communication unit,
wherein the first communication unit makes the wireless communication with the first base station, according to the first protocol, using the information managed by the information manager, and
wherein the second communication unit sends the information in the information manager to the fourth communication unit.

7. The first mobile communication terminal as claimed in claim 6, further comprising:
a first state storage unit configured to store a state of use of the protocol used by each of the first and third communication units; and
a controller configured to stop the first and third communication units when the state of use stored in the first state storage unit and a state of use stored in a second state storage unit of the second mobile communication unit storing the state of use of the protocol used by each of the first and third communication units differ.

8. The first mobile communication terminal as claimed in claim 7, wherein
the second communication unit receives a request for the second information sent from the fourth communication unit of the second mobile communication terminal and supplies the received request to the information manager, and
the information manager generates the second information in response to the request for the second information and sends the generated second information from the second communication unit to the fourth communication unit.

9. The first mobile communication terminal as claimed in claim 7, wherein
an expiry date is provided with respect to the state of use of the protocol used by the third communication unit and stored in the first state storage unit, and
the controller changes the state of use of the protocol used by the third communication unit and stored in the first state storage unit to not-in-use, when the expiry date is reached.

10. A second mobile communication terminal communicatable in a communication system with a first mobile communication terminal including a first communication unit configured to make a wireless communication with a first base station according to a first protocol and to make a wireless communication with a second base station according to a second protocol, an information manager configured to manage information used for the wireless communication according to one of the first and second protocols, and a second communication unit configured to send information used for a wireless communication with the second base station according to the second protocol to another mobile communication terminal according to a third protocol, the second mobile communication terminal comprising:
a third communication unit;
a fourth communication unit configured to make a wireless communication with the first mobile communication terminal according to the third protocol and configured to receive the information used for a wireless communication with the second base station according to the second protocol; and
an information storage unit configured to store the information received by the fourth communication unit,
wherein the information storage unit stores the information that is managed by the information manager, sent from the second communication unit, and received by the fourth communication unit, and
wherein the third communication unit makes a wireless communication with the second base station, according to the second protocol, using the information stored in the information storage unit.

11. The second mobile communication terminal as claimed in claim 10, further comprising:
a second state storage unit configured to store a state of use of the protocol used by each of the first and third communication units; and
a controller configured to stop the first and third communication units when the state of use stored in the second state storage unit and a state of use stored in a first state storage unit of the first mobile communication unit storing the state of use of the protocol used by each of the first and third communication units differ.

12. The second mobile communication terminal as claimed in claim 11, wherein the information used for the wireless communication according to one of the first and second protocols includes first information stored in the information manager and second information generated by the information manager, and the information stored in the information storage unit is the first information.

13. The second mobile communication terminal as claimed in claim 11, wherein
an expiry date is provided with respect to the state of use of the protocol used by the third communication unit and stored in the second state storage unit, and
the controller changes the state of use of the protocol used by the third communication unit and stored in the second state storage unit to not-in-use, when the expiry date is reached.
